(19) United States
(12) Patent Application Publication
(10) Pub. No.: US 2015/0100552 A1
(43) Pub. Date: Apr. 9, 2015

(54) MANAGING NON-COMMITTED COMPUTERIZED WORKFLOWS

(71) Applicant: QQ Solutions Inc., Deerfield Beach, FL (US)

(72) Inventors: Mark A. MALIS, Boca Raton, FL (US); Michael D. STEBEL, Delray Beach, FL (US); Asdrubal HERNANDEZ, Coral Springs, FL (US); Juan BETANCOURT, Boca Raton, FL (US); Jeremy POUND, Boca Raton, FL (US)

(73) Assignee: QQ Solutions Inc., Deerfield Beach, FL (US)

(21) Appl. No.: 14/047,412

(22) Filed: Oct. 7, 2013

(51) Int. Cl. G06F 11/14

(52) U.S. Cl. CPC G06F 11/1435
USPC 707/650

(57) ABSTRACT

Disclosed is a novel software application to retain a plurality of non-committed computerized workflows with pertinent data and states for the purpose of pausing or exiting the workflow and continuing from exact state at a later time or on another computing device. A session folder was developed to address the problem of how to manage a plurality of work-in-process, including data entry forms, database queries and other application functions, for users who must work in an environment of frequent interruptions and who need to work on two or more items at a time. This is a problem faced by users of enterprise software applications and other Web applications. Several embodiments are described.

### BACKGROUND

The present invention generally relates to a software application for workflow management, and more particularly to software that manages non-committed computerized workflows with pertinent data and states.

Users of computer systems and portable devices often times multitask. They may start a workflow process and be interrupted by a telephone call, an email or other disruption. Users often times loose work due to interruptions. This is especially problematic in Web-based and cloud-based solutions in which a workflow for an insurance company or hospital clinical workflow is interrupted. Users often want to suspend or temporarily pause a work-in-process and proceed with another task. The user then comes back to the paused work-in-process at a subsequent time and/or a different computing device. Users also want to switch among paused works-in-process and other items.

One solution to handle interruptions for Web-based workflow is the use of cookies. For example, cookies stored on client devices are used by websites to keep track of items in shipping carts. Although useful, cookies are not synchronized across a user's client devices e.g., computer, tablet, smartphone, and more.

Another solution to handle interruptions for Web-based workflow is to open up additional tabs or browser windows. However, the need to open up additional tabs and browser windows is often times cumbersome. Accordingly, a need exist to handle workflow interruptions, while eliminating the need to open and propagate large numbers of open browser windows, tabs or sessions and the data integrity and user errors they can produce.

### SUMMARY

The presently claimed invention is a novel software application used to retain a plurality of non-committed computerized workflows with pertinent data and state for the purpose of pausing or exiting the workflow and continuing from exact state at a later time or on another computing device. This novel software application solves a problem of saving workflows faced by users of enterprise software applications and other Web applications.

The novel software application includes a session folder with also known as a “Stack”. The session folder allows a user to easily manage a suspended or paused work-in-process. The work-in-process includes data entry forms, database queries, and other application functions. The presently claimed invention is especially helpful for users who must work in an environment of frequent interruptions and who need to multitask by working on two or more items at a time. It is important to note that the term “Stack” is being used as fanciful marketing term or metaphor that the inventors created to save a state of a Web page. It is not related to the abstract stack data type, or to Web session state storage in computer science.

More specifically, disclosed is a novel computer implemented method, system, and computer program product for automatically saving a state of a computer file. The method begins with a computer server providing one or more files for display client machines. These files can be Web pages or Web documents displayed in a Web browser or through other dedicated application or applet. The display file includes one or more user input fields for receiving user input via the client machine. The user input can be received through text and keyboard entry or voice. Each user input field is associated with unique key-value pair.

Next, the method waits to receive user input for one or more of the user input fields. The user input is tentative and not already committed into a storage associate with the display file. When user indicates to save the state of uncommitted input, the method records a state of the display file by storing into the storage file on the computer server each of: i) a current value for each key-value pair; ii) a user identifier of the user; iii) a display file identifier of the display file currently being displayed; and iv) the related context for module and entity. The storage file can be a simple text file or database.

In one example, after the state is recorded, an indicator for display on the client machine is presented to notify that the state of the display has been saved. The indicator could include a number of states, a category, or both. A user can remove saved states from the Stack. Conflicts are detected when a user requests overwriting current information with older information is also disclosed.

### BRIEF DESCRIPTION OF THE SEVERAL VIEWS OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 diagrammatically depicts client-server applications coupled to a distributed computing network;

FIG. 2 is a diagram of a client window as part of a client-server application of FIG. 1;

FIG. 3 is a diagram of a portion of the client window as part of a client-server application of FIG. 2, illustrating the save state button and session state folder;

FIG. 4 is a diagram of a client window as part of a client-server application of FIG. 1, with a session state or “Stack” of saved states;

FIG. 5 is a table of example values saved at the server computer in order to save the states of a client-server application;

FIG. 6 is a flow chart illustrating the saving states of the client-server application by the server computer;

FIG. 7 is a flow chart illustrating the conflict checking saved states of the client-server application by the server computer;

FIG. 8 is a flow chart illustrating the deleting saved states of the client-server application by the server computer; and

FIG. 9 is a block diagram illustrating one example of an information processing system as a server computer of FIG. 1.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### NON-LIMITING DEFINITIONS

The terminology used herein is for the purpose of describing particular embodiments only and is not intended to be limiting of the invention. As used herein, the singular forms “a”, “an” and “the” are intended to include the plural forms as well, unless the context clearly indicates otherwise.

The term “category” is a collection of items with similar attributes stored in the session list on the Stack such as list, individual contacts, corporate contact, policy, and other items depending on a specific industry.

The term “client server application” is any Web page, application, applet or other software that typically collects and stores information in a central repository such as a server.

The term “commit” as it applies in computer science and data management, a commit is the making of a set of tentative changes permanent.

The terms “comprises” and/or “comprising,” specify the presence of stated features, steps, operations, elements, and/or components, but do not preclude the presence or addition of one or more other features, integers, steps, operations, elements, components, and/or groups thereof.

The term “computing device” is any device, such as a computer, smartphone, tablet, television, or other information-processing device in which software can be installed to view various file attachments.

The term “display file” is content in a file being presented to one or more users.

The term “display file identifier” is a unique identifier associated with a multimedia content in a file being presented to one or more users.

The term “file” is a data structure for holding multimedia content to be displayed to a user.

The term “indicator” is an icon, pictogram, or other symbol that conveys meaning through a pictorial representation.

The term “key-value pair” is a user entry in a client-server or online form that is associated with a specific field on that form.

The term “session folder” is a fanciful term for a repository for the session states of a client-server application such as a Web page.

The term “session state” is a list of information used to retain a plurality of non-committed computerized workflows with pertinent data and state for the purpose of pausing or exiting the workflow and continuing from exact state at a later time or on another computing device. As used here, this is not related to the standard session state storage in computer science.

The term “Stack” is a fanciful marketing term or metaphor that we created to save a state of a Web page. It is not related to the data type in computer science.

The term “user input fields” are entries made onto a page or form as part of the content being presented in a display file to a user is a visual area containing some kind of user interface.

The term “work flow” is a sequence of connected or related steps to follow in order to complete a task such as issuing an insurance policy, completing in survey, patient intake, filing a claim, and more.

### Overview

The present invention is a software application to retain a plurality of non-committed computerized workflows with pertinent data and state for the purpose of pausing or exiting the workflow and continuing from exact state at a later time or on another computing device.

The one or more session states are saved in a session folder with also known as a “Stack”. The session folder was developed to address the problem of how to manage a plurality of work-in-process, including data entry forms, database queries and other application functions, for users who must work in an environment of frequent interruptions and who need to work on two or more items at a time. This is a problem faced by users of enterprise software applications and other Web applications.

Specifically, the presently claimed invention addresses the problem of: (1) how to pause a work-in-process, proceed with another task and then come back to it at a subsequent time and/or a different computing device; and (2) how to switch among paused works-in-process and other items; and (3) how to handle workflow interruptions, while eliminating the need to open and propagate large numbers of open browser windows, tabs or sessions, and the data integrity and user errors they can produce.

Unlike other solutions, such as bookmarks, which save only the URL, or address, of a Web page and neither its current Web application state nor user-entered data; and, unlike approaches using “cookies,” which are stored on the client device and do not provide an ability for the user to switch among multiple items, this invention saves the exact Web application state and all data entered on the page by the user via an elegant user interface to save, or “Stack,” the user's work-in-process, and a pop-up index of all the “Stacked” items for retrieval. Effectively, this allows work-in-process to be paused and continued at a subsequent time and/or using a different device.

### Distributed Computer System

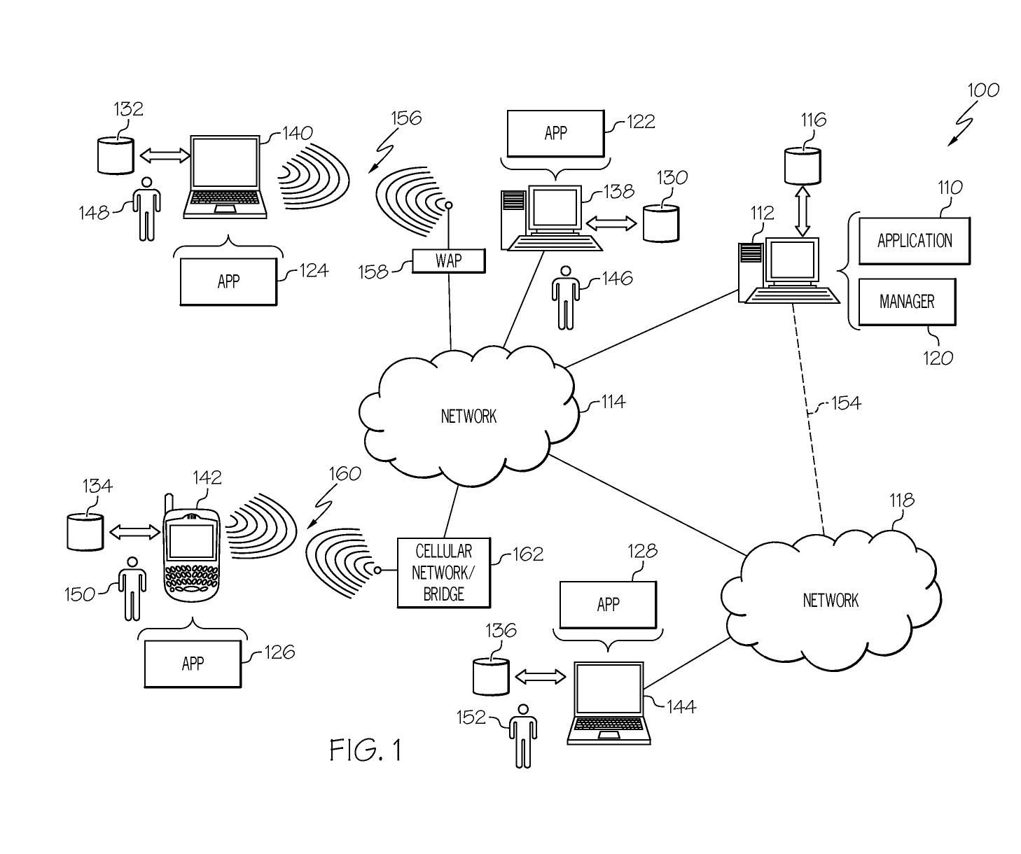

Referring to FIG. 1, there is a distributed computer system 100 that may be used to carry out the trial use of a software application. In one example, the trial software application may reside on and be executed by server computer 120, which may be connected to network 114 e.g., the Internet or a local area network. Examples of server computer 120 may include, but are not limited to: a personal computer, a server computer, a series of server computers, a mini computer, and a mainframe computer. Server computer 120 may be a Web server or a series of servers running a network operating system, examples of which may include but are not limited to Microsoft Windows Server or Linux, for example. Alternatively, email propagation process may reside on a client electronic device, such as a personal computer, notebook computer, smartphone, tablet, or the like. As will be discussed below in greater detail, an email user is presented on the email program different icons representing applications to open attachments. One an icon is selected by the user, the trial software is installed, launched and the file attachment opened.

The instruction sets and subroutines of the process to present trial software applications to the user 110, which may be stored on storage device 116 coupled to server computer 112, may be executed by one or more processors (not shown) and one or more memory architectures (not shown) incorporated into server computer 112. Storage device 116 may include but is not limited to: a hard disk drive; a tape drive; an optical drive; a RAID array; a random access memory (RAM); and a read-only memory (ROM).

Server computer 112 may execute a Web server application, examples of which may include but are not limited to Microsoft IIS server or Apache server that allows for HTTP (i.e., HyperText Transfer Protocol) access to server computer 112 via network 114. Network 114 may be connected to one or more secondary networks e.g., network 118, examples of which may include but are not limited to: a local area network; a wide area network; or an intranet, for example.

Server computer 112 may execute server application 110 and state manager 120. Server application 120 may be directly integrate with state manager 120 or use application programming interfaces to use the software routines in state manager 120. The server application serves display files, such as Web pages, or application pages, to one or more client client-server applications 122, 124, 126, 128. In another example, the client-server applications 122, 124, 126, 128 may be apps or applets downloaded to install and run on the one or more client electronic devices 138, 140, 142, 144 stored on storage devices 130, 132, 134, 136, respectively.

The instruction sets and subroutines of email server application 120, which may be stored on storage device 116 coupled to server computer 112 may be executed by one or more processors (not shown) and one or more memory architectures (not shown) incorporated into server computer 112.

As a client-side application may, e.g., be a standalone application, interface with other client application, or may be an applet/application that is executed within a client application. Accordingly, application may be a server-based process, a client-side process and/or may be a hybrid client-side/server-based process, which may be executed, in whole or in part, by Web application and by server application.

The instruction sets and subroutines of client client-server applications 122, 124, 126, 128, which may be stored on storage devices 130, 132, 134, 136 (respectively) coupled to client electronic devices 138, 140, 142, 144 (respectively), may be executed by one or more processors (not shown) and one or more memory architectures (not shown) incorporated into client electronic devices 138, 140, 142, 144 (respectively). Storage devices 130, 132, 134, 136 may include but are not limited to: hard disk drives; solid state drives (SSD) tape drives; optical drives; RAID arrays; random access memories (RAM); read-only memories (ROM), compact flash (CF) storage devices, secure digital (SD) storage devices, and a memory stick storage devices. Examples of computing devices 138, 140, 142, 144 may include, but are not limited to, personal computer 138, laptop computer 140, smartphone 142, notebook or tablet computer 144, and a dedicated network device (not shown). Using client applications 122, 124, 126, 128, users 146, 148, 150, 152 may access server application 110 and may send, retrieve and/or organize data and other messages.

Users 146, 148, 150, 152 may access server application 120 directly through the device on which the email client applications 122, 124, 126, 128 are executed, namely on client electronic devices 138, 140, 142, 144. Users 146, 148, 150, 152 may access server application 120 directly through network 114 or through secondary network 118. Further, server computer 112 (i.e., the computer that executes email server application 120) may be connected to network 114 through secondary network 118, as illustrated with phantom link line 154.

The various client electronic devices may be directly or indirectly coupled to network 114 (or network 118). For example, personal computer 138 is shown directly coupled to network 114 via a hardwired network connection. Further, notebook computer 144 is shown directly coupled to network 118 via a hardwired network connection. Laptop computer 140 is shown wirelessly coupled to network 114 via wireless communication channel 156 established between laptop computer 140 and wireless access point (i.e., WAP) 158, which is shown directly coupled to network 114. WAP 158 may be, for example, an IEEE 802.11a/b/g/n Wi-Fi, and/or Bluetooth device that is capable of establishing wireless communication channel 156 between laptop computer 140 and WAP 158. Personal digital assistant 142 is shown wirelessly coupled to network 114 via wireless communication channel 160 established between smart phone 142 and cellular network/bridge 162, which is shown directly coupled to network 114.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., smartphones, tablets, computers, peripherals and other devices to be interconnected using a short-range wireless connection.

Client electronic devices 138, 140, 142, 144 may each execute an operating system, examples of which may include but are not limited to Microsoft Windows, Apple OS X, Apple iOS, Google Android, Linux, or custom operating system.

### Client Software Application

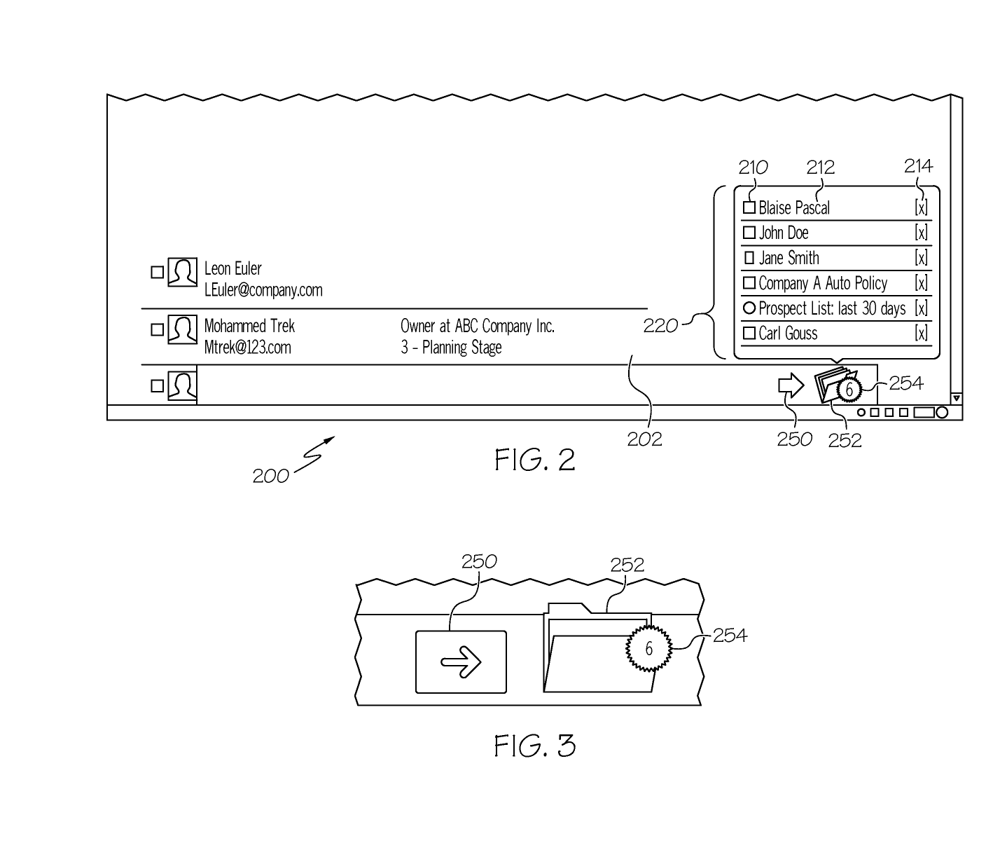

Referring also to FIG. 2, shown is a diagram of a client window 200 as part of a client-server application 122, 124, 126, 128 of FIG. 1. Shown is an application 202. A plurality of information for each session state 220 or Stack entry is shown. This information for the session state 220 may be shown in response to a user selection. The user selection may be a mouse hover or mouse selection. The session state folder 220 is used by a user to manage previously saved sessions. The values entered by a user into any open client-server application screen, browser tab, or application window can be added to the list in the session state 220. Examples of application screens include but are not limited to lists, reports, contact information, customer and client information, prospect screens, policies, and more. An icon 210, such as a category icon, and text field descriptor 212 assists the user with quickly identifying what type client-server state each of the items in the session state 220 represents.

Further, simply by clicking with a mouse or otherwise selecting an entry in the session state 220, the screen or Web-tab is restored with the information previously saved. The user can remove an entry from the list of entries in the session state 220, simply by selecting a delete box 214. This process will be described further with reference to flow chart in FIG. 8 below.

A detailed view of the save selectable icon 250 and session state folder icon 252 from which the session state 220 is shown to in FIG. 3. In this example, the selectable icon 250 is an “arrow” but other shapes and icons can be used. The user selects the selectable icon 250 in order to save a session state. In this example, a “count” 254 of the number of saved session states is also shown on top of the folder icon 252. This count is important on client devices, such as with mobile devices with limited screen real estate, to communicate additional information to the user. Moreover, there may be an optional maximum number of states that can be saved because the session state 220 may not fit on one screen. The use of elevator controls and scrolling control can be used in these situations as well.

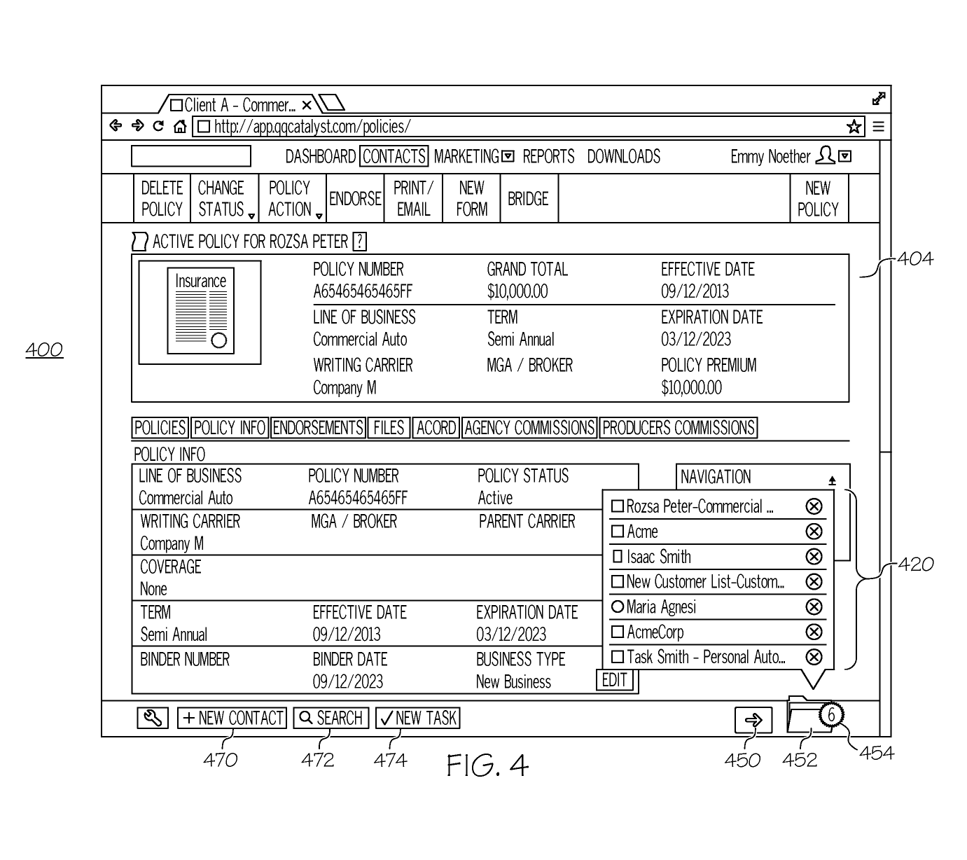

FIG. 4 is a diagram of an example client window 400 as part of a client-server insurance application of FIG. 1, with a list of session states 420. It is important to note that information entered into other fields 404 or selected using button 470, 472, 474 may be non-committed data and can be saved by the user using selectable icon 450. Only information that is non-committed data is saved and information added to the session state 420. Information that may already be committed data is not saved and added to the session state 420.

### Table of Information for a Saved State

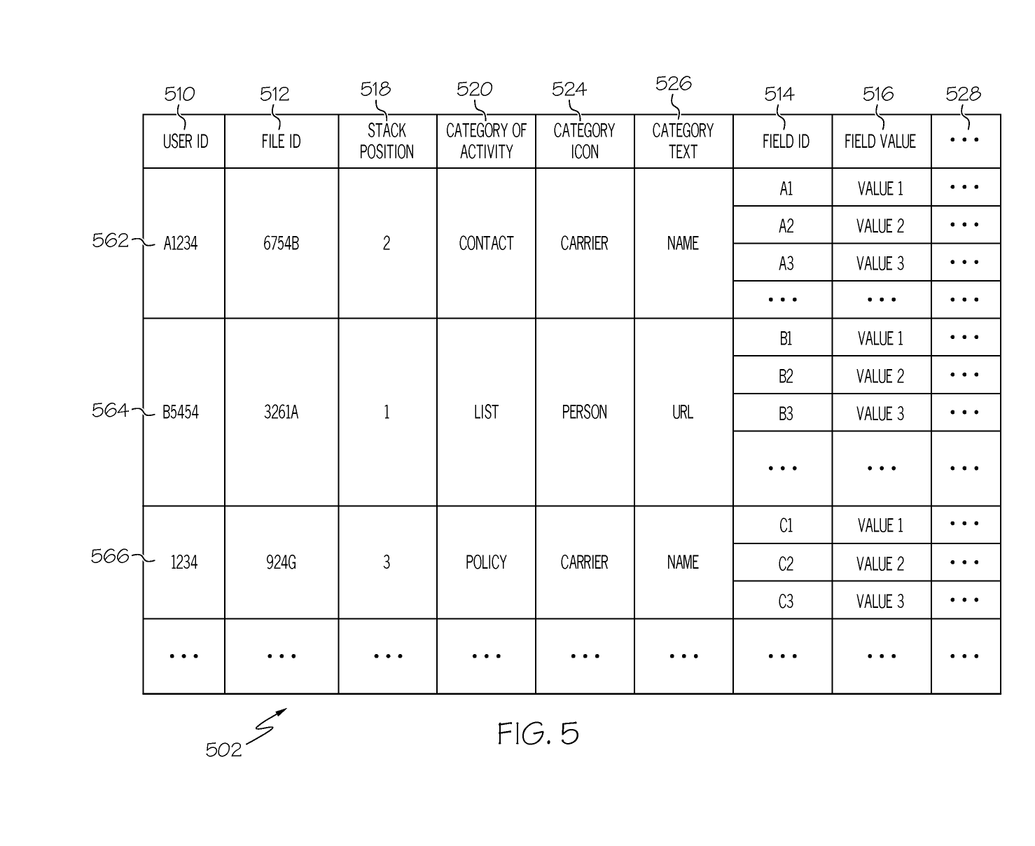

FIG. 5 is a table of example values saved at the server computer in order to save the states of a client-server application. Shown are a series of row 562, 564, 566, each representing a saved state, such as one of the entries in the list of session states 320 and 420. For example, row 562 includes entries for User ID 510. This is used to uniquely identify a user across multiple sessions and across multiple client platforms. A File ID 512 is used to identify a particular file or page or Web-browser tab or screen of a client-server application with non-committed data. For each File ID 512, shown is a plurality of Field IDs 514. Stated differently, each file or page or Web-browser tab or screen of a client-server application with non-committed data has one or more fields. The specific values enter by the user into these fields via a mouse, keyboard, or voice or other type of input to form the corresponding values 516. The Filed ID 514 and corresponding Field Value 516 together form the key-value pairs. An optional Stack position 518 is shown. This Stack position 518 may be important in data structure implementations, in which keeping track of relative position of information is important. Also shown is a category of activity 520. Example categories shown include “Task”, “Contact”, “Report”, “Policy”, “Person”, “Carrier” and more. Different or additional categories and corresponding category icons 524 are contemplated in this invention. Typically, the exact types of categories will be governed by the type of client-server application being used. Moreover, these categories can be dynamic, especially text of a category 526 such as Web-page with a URL, a name for a person or company, or document with properties displayed.

### Process Flows

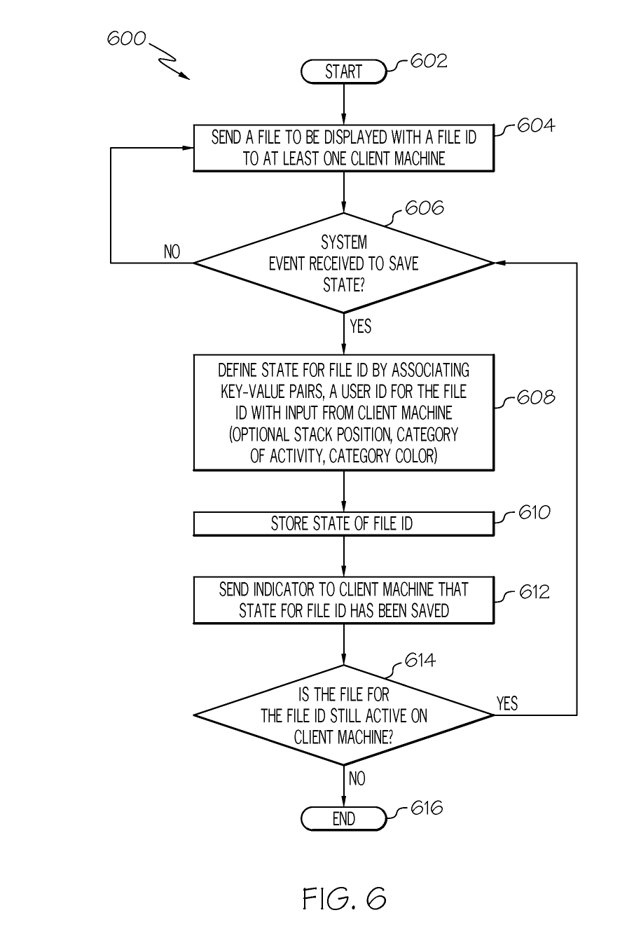

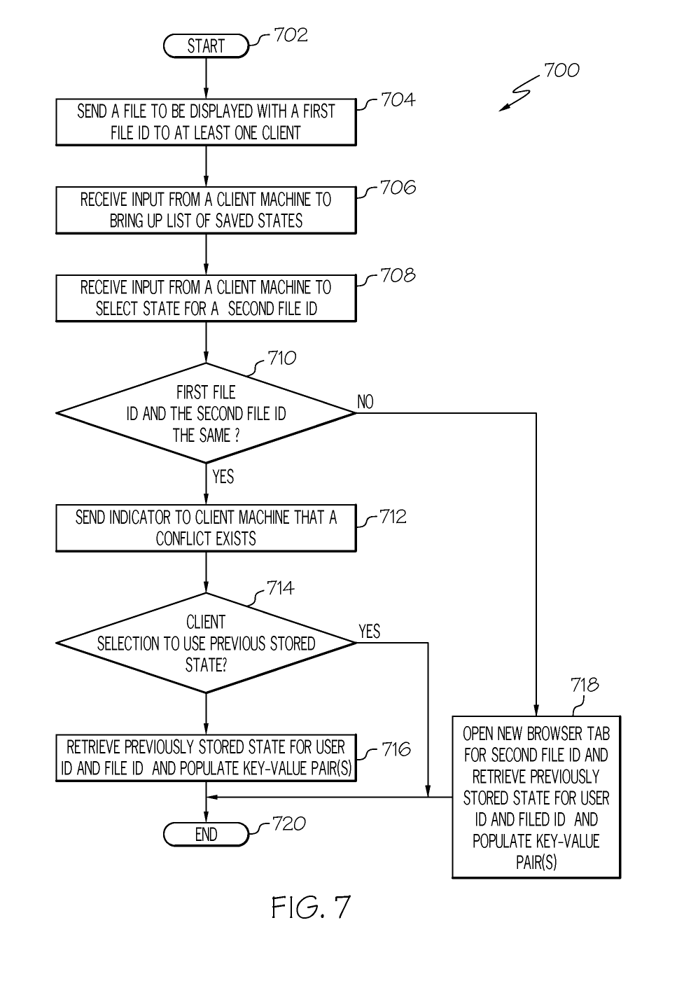

FIG. 6 is a flow chart 600 of saving states of the client-server application by the server computer. The process begins in step 602 and immediately proceeds to step 604, in which a file, such as client-server application, applet, Web page, or other multimedia content is sent from server computer 112 to one or more client electronic devices 138, 140, 142, 144. The process loops or waits for a system event to be received. The system event acts as a trigger to save the session state in step 606. In one example, a system event is the user activating or selecting the selectable icon 250 on a client electronic device. The system event in other examples include in activity-timer, in which the system state is automatically saved after a certain period of time. This period of time can be set by a user or by the system administrator based on the type of file being displayed. Another example of a system event is a user action such as changing focus from one screen to another screen, switching Web pages, or switching views into a database. Other system events are contemplated within the true scope of the presently claimed invention.

In response to the system event being received in step 606, information, such as the information in one of the rows in the Table 500 of FIG. 5 is saved. This information is non-committed data. This information is stored at the server computer 112, such as storage device 116. The information may be stored in a simple text file or in a database. An indicator is sent to the client electronic device to notify the user that the session state is saved. In the event the file is still active on the client electronic device, the process loops back to waiting for system event in step 606. Otherwise the process flow exits in step 616 when the file is no longer active on the client electronic device.

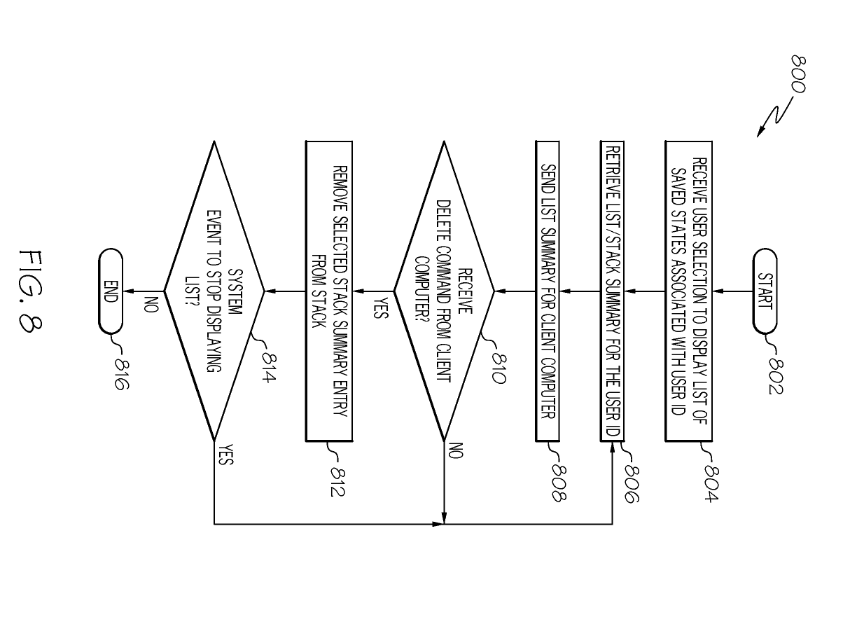

Turning to FIG. 7 is a flow chart 700 of conflict checking saved states of the client-server application by the application computer 112. The process begins in step 702 and immediately proceeds to step 704, in which a file, such as client-server application, applet, Web page, or other multimedia content with a specific File ID is sent from server computer 112 to one or more client electronic devices 138, 140, 142, 144. Input is received from one of the client machines to bring up a list in the session state 220. This list may be requested by the user selecting with a mouse, keyboard or voice input the session folder 252. Once the list in the session state 220 is being displayed on one of the client electronic devices, upon receiving user input for a select state, a test is made in step 710 is the second File ID is the same as the First File ID. In the event the File IDs are differently, the process continues to step 718 in which the second File ID is sent from server computer 112 to the client electronic device for display. Note by using the information in Table 500 of FIG. 5 a previously stored File ID can be populated with the key-value pairs such as in a new browser tab or a new instance of an application or applet.

Otherwise, in the event that the First File ID and the Second File ID are identical, the process continues to step 720 in which an indicator or warning is sent from server computer 112 to the client electronic device for display. In the event, the user on the client electronic device selects to use a previously stored state to the process continues to step 718 in which the second File ID is sent from server computer 112 to the client electronic device for display and the process ends in step 720. Otherwise, the previous stored state for User ID and File ID and populate key-values pair(s) and populate a file with key-value pairs(s).

Turning FIG. 8 is a flow chart 800 of deleting saved states of the client-server application by the server computer 112. The process begins in step 802 and immediately proceeds to step 804, in which input is received from one of the client machines to bring up a list in the session state 220. This list may be requested by the user selecting with a mouse, keyboard or voice input the session folder 252. The correct list is retrieved based on the User ID 510 in Table 500 of FIG. 5. The using Table 500 the values stored in a row, corresponding to the User ID, are sent to the client computer 808. A test is made whether a delete command in step 810 is received from the user. In the event no delete command is received, the process loops back to step 806. Otherwise, in response to a delete command being received, the process continues to step 812 in which the entry is removed from the list in the session state 220 or Stack. The list is updated and displayed. In the event the user indicates that the system should stop displaying the list the process stops in step 816. Otherwise, the process loops back to step 806.

### Information Processing System

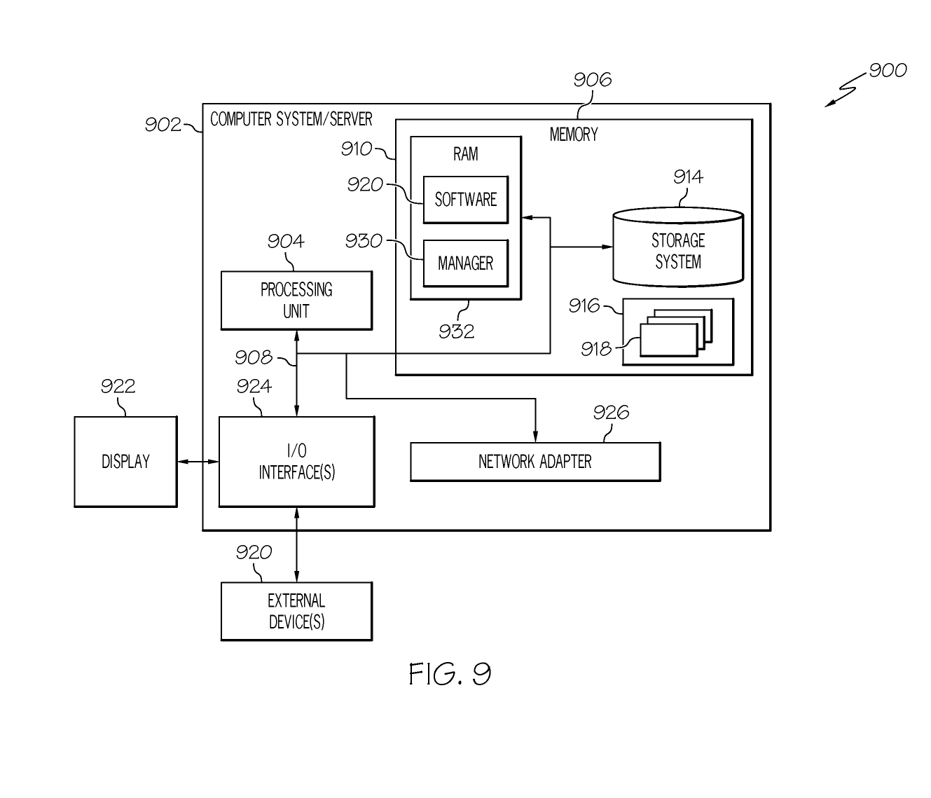

Referring now to FIG. 9, this figure is a block diagram 900 illustrating an information processing system that can be utilized in embodiments of the present invention. The information processing system 902 is based upon a suitably configured processing system configured to implement one or more embodiments of the present invention (e.g., the Manager 110 of FIG. 1). Any suitably configured processing system can be used as the information processing system 902 in embodiments of the present invention. The components of the information processing system 902 can include, but are not limited to, one or more processors or processing units 904, a system memory 906, and a bus 908 that couples various system components including the system memory 906 to the processor 904.

The bus 908 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Although not shown in FIG. 9, the main memory 906 includes the manager 110. The manager 110 can reside within the processor 904, or be a separate hardware component. The system memory 906 can also include computer system readable media in the form of volatile memory, such as random access memory (RAM) 910 and/or cache memory 912. RAM 910 includes a trial software manager 920 and sorting factor 930, such as those shown in FIG. 10

The information processing system 902 can further include other removable/non-removable, volatile/non-volatile computer system storage media. By way of example only, a storage system 914 can be provided for reading from and writing to a non-removable or removable, non-volatile media such as one or more solid-state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 908 by one or more data media interfaces. The memory 906 can include at least one program product having a set of program modules that are configured to carry out the functions of an embodiment of the present invention.

Program/utility 916, having a set of program modules 918, may be stored in memory 906 by way of example, and not limitation, as well as an operating system, one or more application programs, other program modules, and program data. Each of the operating system, one or more application programs, other program modules, and program data or some combination thereof, may include an implementation of a networking environment. Program modules 918 generally carry out the functions and/or methodologies of embodiments of the present invention.

The information processing system 902 can also communicate with one or more external devices 920 such as a keyboard, a pointing device, a display 922, etc.; one or more devices that enable a user to interact with the information processing system 902; and/or any devices (e.g., network card, modem, etc.) that enable computer system/server 902 to communicate with one or more other computing devices. Such communication can occur via I/0 interfaces 924. Still yet, the information processing system 902 can communicate with one or more networks such as a local area network (LAN), a general wide area network (WAN), and/or a public network (e.g., the Internet) via network adapter 926. As depicted, the network adapter 926 communicates with the other components of information processing system 902 via the bus 908. Other hardware and/or software components can also be used in conjunction with the information processing system 902. Examples include, but are not limited to: microcode, device drivers, redundant processing units, external disk drive arrays, RAID systems, tape drives, and data archival storage systems.

### Non-Limiting Examples

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), Solid State Drive (SSD), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, C#, C++, PHP, Ruby, Python, or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method for automatically saving a state of a computer file, the method comprising:
providing, by a computer server, at least one display file for display on at least one client machine, the display file including one or more user input fields for receiving user input via the client machine, wherein each user input field is associated with unique key-value pair;
in response to receiving user input for at least one of the user input fields and the user input is tentative and not already committed into a storage file associate with the display file, recording a state of the display file by storing into the storage file on the computer server each of
a current value for each key-value pair;
a user identifier of the user, and
a display file identifier of the display file currently being displayed.

2. The method of claim 1, wherein the display file is a Web page being displayed in a Web browser on the client machine.

3. The method of claim 1, wherein the storage file is a database file.

4. The method of claim 1, further comprising:
presenting an indicator for display on the client machine to indicate that the state of the display has been saved.

5. The method of claim 4, wherein the indicator includes a number of states that have been recorded for the user.

6. The method of claim 4, wherein the indicator includes an icon of a category of the state being saved.

7. The method of claim 6, wherein the category is one of a contact, a task, a new customer list, a picture, a sound file, a video, or a combination thereof.

8. The method of claim 4, wherein the indicator includes a delete icon that when selected by the user removes a state that has been recorded from a list of all states that have been recorded.

9. The method of claim 1, wherein the recording of the state of the display file into the storage file is recorded as a Stack with an associated last-in-first-out data structure.

10. A computing device for automatically saving a state of a computer file, the computing device comprising:
a memory;
a processor communicatively coupled to the memory, where the processor is configured to perform
providing, by a computer server, at least one display file for display on at least one client machine, the display file including one or more user input fields for receiving user input via the client machine, wherein each user input field is associated with unique key-value pair;
in response to receiving user input for at least one of the user input fields and the user input is tentative and not already committed into a storage file associate with the display file, recording a state of the display file by storing into the storage file on the computer server each of
a current value for each key-value pair;
a user identifier of the user, and
a display file identifier of the display file currently being displayed.

11. The computing device of claim 10, wherein the display file is a Web page being displayed in a Web browser on the client machine.

12. The computing device of claim 10, wherein the storage file is a database file.

13. The computing device of claim 10, further comprising:
presenting an indicator for display on the client machine to indicate that the state of the display has been saved.

14. The computing device of claim 13, wherein the indicator includes a number of states that have been recorded for the user.

15. The computing device of claim 13, wherein the indicator includes an icon of a category of the state being saved.

16. The computing device of claim 15, wherein the category is one of a contact, a task, a new customer list, a picture, a sound file, a video, or a combination thereof.

17. The computing device of claim 14, wherein the indicator includes a delete icon that when selected by the user removes a state that has been recorded from a list of all states that have been recorded.

18. The computing device of claim 10, wherein the recording of the state of the display file into the storage file is recorded as a Stack with an associated last-in-first-out data structure.

19. A non-transitory computer program product for automatically saving a state of a computer file, the computer program product configured to:
providing, by a computer server, at least one display file for display on at least one client machine, the display file including one or more user input fields for receiving user input via the client machine, wherein each user input field is associated with unique key-value pair;
in response to receiving user input for at least one of the user input fields and the user input is tentative and not already committed into a storage file associate with the display file, recording a state of the display file by storing into the storage file on the computer server each of
a current value for each key-value pair;
a user identifier of the user, and
a display file identifier of the display file currently being displayed.

20. The non-transitory computer program product of claim 19, wherein the display file is a Web page being displayed in a Web browser on the client machine.
